(19) United States
(12) Patent Application Publication
(10) Pub. No.: US 2009/0244118 A1
(43) Pub. Date: Oct. 1, 2009

(54) Printing Device, Print Control Device, and Printing Method

(75) Inventor: Toshiaki Kakutani, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/411,490

(22) Filed: Mar. 26, 2009

(30) Foreign Application Priority Data
Mar. 26, 2008 (JP) 2008-079713

(51) Int. Cl. B41J 29/38

(52) U.S. Cl. 347/6

(57) ABSTRACT

Provided is a printing device which prints an image using a metallic ink and a color ink, the device including: a recording unit which records the metallic ink and the color ink on a printing medium; an input unit which inputs image data; a metallic ink region specifying unit which specifies a region using the metallic ink, in the formation of the image according to the input image data; and a print control unit which prints the image while the color ink is formed relatively larger than that of a region without using the metallic ink, in the region using the metallic ink.

This application is based upon and claims the benefit of priority from the prior Japanese Patent Applications No. 2008-079713, filed on Mar. 26, 2008, the entire content of which is incorporated herein by reference.

### BACKGROUND

1. Technical Field

The present invention relates to a technology of printing an image using a metallic ink and a color ink. In the present specification, an ink includes a toner, which is attached to a latent image formed on a photosensitive drum and is transferred, or a coloring material transferred from an ink ribbon to a sheet by a process such as thermal fusion, or a dye-based ink in which a dye is melted in a solvent, or a pigment-based ink in which a pigment is dispersed in a solvent.

2. Related Art

In an electrophotographic field, a technology of printing an image using both a process color toner and a metallic toner with respect to a portion of image data to be printed, in which a metallic color is specified, and printing an image using only the process color toner with respect to a remaining portion is suggested (JP-A-2006-50347).

Also, a metallic ink has been developed in the field of an ink jet printer for ejecting ink droplets onto a printing medium and performing printing. However, in the ink jet printer, since the sizes of ejected ink droplets are small, an image formed by a color ink is dulled in a region in which both the metallic ink and the color ink are used. Accordingly, although the formation of the image using the metallic ink is possible, it is difficult to sufficiently utilize the characteristics of the metallic ink.

### SUMMARY

An advantage of some aspects of the invention is that printing capable of solving the above-described problems is realized. Moreover, printing using metallic ink and color ink and sufficiently utilizing the characteristics of a metallic ink is realized.

According to an aspect of the invention, there is provided a printing device that prints an image using a metallic ink and a color ink, the device includes a recording unit that records the metallic ink and the color ink on a printing medium; an input unit that inputs image data; a metallic ink region specifying unit that specifies a region using the metallic ink, in the formation of the image according to the input image data; and a print control unit that prints the image while the color ink in the region using the metallic ink is formed relatively larger than that of a region without using the metallic ink.

In such a printing device, the printing of the image is performed while the color ink in the region using the metallic ink is formed relatively larger than in the region without using the metallic ink. Accordingly, the color ink is formed with a large size in the region in which the metallic ink and the color ink are mixed, a scattering ratio of incident light is decreased and the dullness of the color ink is suppressed. As a result, the printing with sufficient metallic ink characteristics can be performed. The “dullness” of the color ink indicates a state in which a gloss quality is partly or wholly lost because incident light is scattered in a plurality of color ink regions if the color ink having a small size is formed.

In the printing device, the print control unit may make the dots of the color ink recorded from the recording unit large in the region using the metallic ink.

In this configuration, since the dots of the color ink are large, it is possible to reduce the dullness of the color ink.

In the printing device, the recording unit can form at least two or more types of dots having different sizes, and the print control unit may increase a formation ratio of a large dot of the two or more types of dots in the dots of the color ink recorded from the recording unit, with respect to the region using the metallic ink.

In this configuration, the formation ratio of the large dot of the two or more types of dots is increased in the region using the metallic ink. Accordingly, even in the region using the metallic ink or the region without using the metallic ink, a possibility that the two or more types of dots formed are present is not changed, but the ratio of the large dots is increased in the dots of the color ink in the region using the metallic ink and thus the dullness of the color ink of the region using the metallic ink can be reduced overall.

In the printing device, the recording unit can form large, intermediate and small dots, and the print control unit may increase a formation ratio of the large dot of the large, intermediate and small dots in the dots of the color ink recorded from the recording unit, with respect to the region using the metallic ink.

If the three types of dots, that is, the large, intermediate and small dots can be formed, similarly, the dullness of the color ink is suppressed by increasing at least the formation ratio of the large dot in the region using the metallic ink.

In the printing device, the metallic ink region specifying unit may extract at least one of a setting region set by a user, a non-skin color region other than a region in which a skin color occupies a predetermined area, a character region in which characters are present, or a contour region in which a contour of image data is present, and specify the extracted region as the region using the metallic ink.

If such a region is used as the region using the metallic ink, the metallic ink can be efficiently used. For example, if the region set by the user is used, the effect of the metallic ink can be obtained in a desired region. If the non-skin color region other than the region in which the skin color occupies the predetermined area is used, unnatural impression is not generated due to the mixture of the skin color of a person and the metallic ink. If the character region in which characters are present is used, a unique effect may be given to the characters. In addition, if the contour region in which the contour of the image data is present is used, the contour can be emphasized.

In the printing device, the print control unit may form the dots of the color ink so as to be superimposed on the dots formed by the metallic ink, with respect to the region using the metallic ink of an opaque print medium.

In this configuration, since the color ink is formed so as to be superimposed on the metallic ink, a representation using the color ink without covering the color ink with the metallic ink is realized.

In the printing device, the print control unit may form the dots of the metallic ink so as to be superimposed on the dots formed by the color ink, with respect to the region using the metallic ink of a transparent print medium.

In this configuration, a transparent medium is used as the printing medium. In this case, the printed image is viewed through the printing medium and the color ink is not covered with the metallic ink. As a result, a representation using the color ink is realized.

In the printing device, the print control unit may form the dots of the color ink and the dots of the metallic ink without being superimposed, with respect to the region using the metallic ink.

In this configuration, the metallic ink and the color ink are not superimposed and thus the problem due to the superimposing of the inks does not occur. Even in this case, the dullness of the color ink is suppressed without changing the formation of the color having a large size.

In the printing device, at least one of a unit that performs recording by ejecting ink droplets from nozzles by distortion of a piezo element, a unit that performs recording by ejecting ink droplets from the nozzles by bubbles generated by heating of a heater, and a unit that performs recording by attaching a toner to a latent image formed on an optical drum and transferring the toner to paper may be employed as the recording unit.

The invention embodied as the printing device also may be embodied as a print control device that allows a printing device including a recording unit, which records a metallic ink and a color ink on a printing medium, to print an image. The invention may be embodied as a printing method that prints an image using a metallic ink and a color ink by a printing device or a computer program that prints an image using a printing device including a recording unit, which records using a metallic ink and a color ink on a printing medium. Such a computer program may be recorded in a computer-readable recording medium. As the recording medium, for example, various media such as a flexible disc, a CD-ROM, a DVD-ROM, a magneto optical disc, a memory card, a hard disc or the like may be used.

### BRIEF DESCRIPTION OF THE DRAWINGS

The invention will be described with reference to the accompanying drawings, wherein like numbers reference like elements.

FIG. 1 is a block diagram showing the schematic configuration of a printing system 10.

FIG. 2 is a view showing the configuration of a computer 100 as a print control device.

FIG. 3 is a view showing the configuration of a printer 200.

FIG. 4 is a flowchart showing an image printing process according to an example of the invention.

FIG. 5 is a flowchart showing several processes of specifying a predetermined region according to a first example of the invention.

FIG. 6 is a flowchart showing a halftone process according to the first example of the invention.

FIG. 7 is a view showing a dot recording ratio table T1 employed in the first example of the invention.

FIG. 8 is a view showing another dot recording ratio table T2 employed in the first example of the invention.

FIG. 9 is a flowchart showing the outline of a printing process according to the first example of the invention.

FIG. 10 is a view showing a print state using a metallic ink and a color ink.

FIG. 11 is a view showing a print state in the related art.

FIG. 12 is a view showing a dot recording ratio table T11 in a modified example.

FIG. 13 is a view showing a print state of a metallic ink and a color ink in the modified example.

FIG. 14 is a view showing main portions of a second example of the invention.

### DESCRIPTION OF EXEMPLARY EMBODIMENTS

Hereinafter, the embodiments of the invention are described in following order:
A. Outline of Embodiments
B. Device Configuration
C. First Example
D. Second Example

### A. Outline of Embodiments

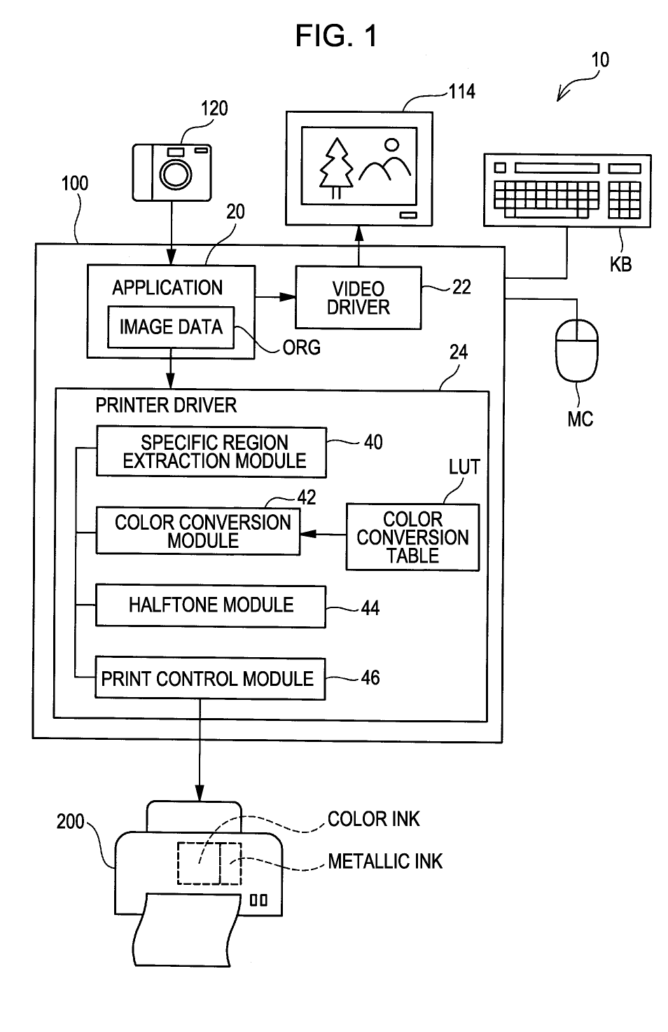

FIG. 1 is a block diagram showing the schematic configuration of a printing system 10 according to an embodiment of the invention. As shown, the printing system 10 according to the present embodiment includes a computer 100 as a print control device and a printer 200 for printing an image under the control of the computer 100. The printing system 10 functions as a broadly-defined printing device, of which the whole may be integrally formed.

In the printer 200 of the present embodiment, a pigment-based cyan ink, a pigment-based magenta ink, a pigment-based yellow ink and a pigment-based black ink are included as a color ink, and a glossy metallic ink is further included. As the metallic ink, for example, an ink composition containing a pigment of a metal foil piece, an organic solvent, and a fixing resin is employed. In the example, a metal foil piece having an average thickness of approximately 30 nm or more and approximately 100 nm or less, an approximately 50% volume-average particle diameter of approximately 1.0 μm or more and approximately 4.0 μm or less, and a maximum particle diameter in particle size distribution of approximately 12 μm or less is employed. As described above, in the present embodiment, a “color ink” includes a black ink.

In the computer 100, a predetermined operating system is installed, and an application program 20 is operated by this operating system. In the operating system, a video driver 22 or a printer driver 24 is assembled. When a user of the computer 100 uses the application program 20 using a keyboard KB or a mouse MC, the application program 20 inputs image data ORG from a digital camera 120, for example, via a peripheral interface 108. Then, the application program 20 displays the image data ORG on a display 114 via the video driver 22. In addition, the application program 20 outputs the image data ORG to the printer 200 via the printer driver 24. The image data ORG received from the digital camera 120 by the application program 20 may be specified in three color components of red (R), green (G) and blue (B).

A specific region extraction module 40, a color conversion module 42, a halftone module 44 and a print control module 46 are included in the printer driver 24.

The specific region extraction module 40 extracts a region having a predetermined feature from the image data ORG received from the application program 20 as a specific region. A detailed example of the specific region is described in the examples below.

The color conversion module 42 converts the color components R, G and B of the image data ORG into color components (cyan (C), magenta (M), yellow (Y) and black (K)), which can be represented by the printer 200, according to a color conversion table LUT prepared in advance.

The halftone module 44 performs a halftone process of representing gradation of the color-converted image data by a dot distribution. In the present embodiment, a known systematic dither method is used as this halftone process. Alternatively, as the halftone process, in addition to the systematic dither method, an error diffusion method, a concentration pattern method or any other halftone techniques may be used.

The print control module 46 rearranges the halftone-processed image data in transmission order to the printer 200 and outputs the data to the printer 200 as printing data. In addition, the print control module 46 outputs various commands such as a print start command or a print end command to the printer 200 so as to control the printer 200.

In the present embodiment, the printer driver 24 recognizes a specific region (a region using the metallic ink) extracted by the specific region extraction module 40 and a region (a region without using the metallic ink) exclusive of the specific region, performs printing using the metallic ink and the color ink in the former region, and performs printing using only the color ink in the latter region. When the metallic ink is color-converted from RGB into CMYK by the color conversion module 42, a ratio of dot formation using the metallic ink is not specified, but is used with respect to a predetermined specific region such that a specific effect (for example, metallic luster) or the like is realized. Accordingly, the metallic ink is generally used based on a specific design request such as a background color of a label sheet or the like, rather than used for reproduction of an image. In the present example, when the application program processes an image, this region is specified to use the metallic ink or the metallic ink is set to be used when an image has a specific property. The printer driver 24 decides whether or not the metallic ink is actually used and allows the printer 200 to perform printing using the metallic ink.

### B. Device Configuration:

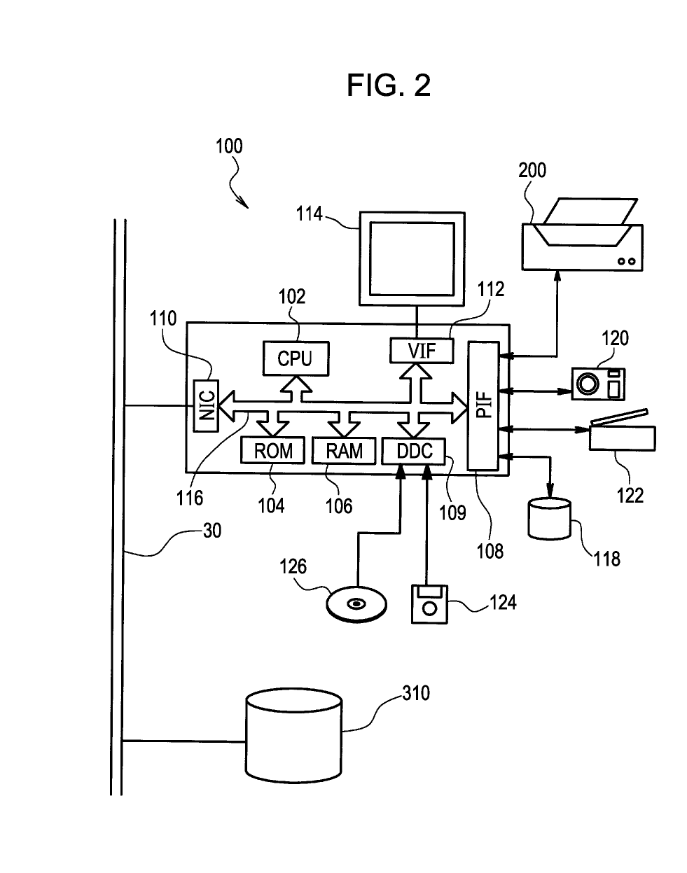

FIG. 2 is a view showing the configuration of the computer 100 as the print control device. The computer 100 is a known computer that is configured by connecting a CPU 102, a ROM 104 or a RAM 106, and so on by a bus 116.

A disc controller 109 for reading data of a flexible disc 124, a compact disc 126 or the like, a peripheral interface 108 for transmitting or receiving data to or from a peripheral, and a video interface 112 for driving the display 114 is connected to the computer 100. The printer 200 or a hard disc 118 is connected to the peripheral interface 108. When the digital camera 120 or a color scanner 122 is connected to the peripheral interface 108, an image process may be performed with respect to an image captured by the digital camera 120 or the color scanner 122. When a network interface card 110 is mounted, the computer 100 may be connected to a network 30 and data stored in a storage 310 connected to the network 30 may be acquired. When image data to be printed is acquired, the computer 100 controls the printer 200 by the operation of the above-described printer driver 24 such that the image data is printed.

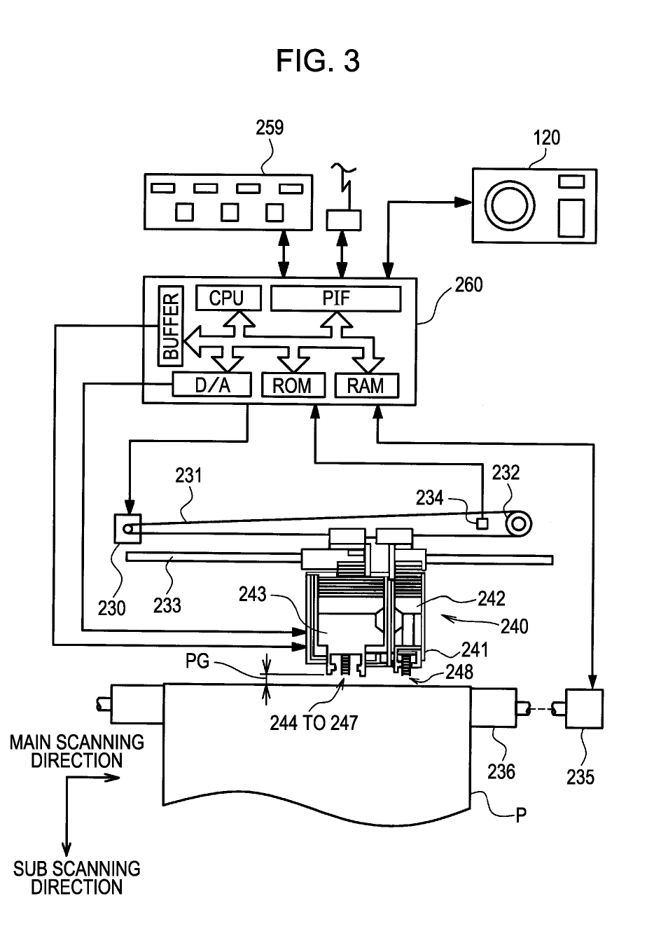

Next, the configuration of the printer 200 is described with reference to FIG. 3. As shown in FIG. 3, the printer 200 includes a mechanism for transporting printing paper P by a paper sheet motor 235, a mechanism for reciprocally moving a carriage 240 by a carriage motor 230 in an axial direction of a platen 236, a mechanism for driving a printing head 241 mounted in the carriage 240, ejecting an ink, and forming dots, and a control circuit 260 for managing the signal transmission/reception of the paper feed motor 235, the carriage motor 230, the printing head 241 and an operation panel 256.

The mechanism for reciprocally moving the carriage 240 in the axial direction of the platen 236 includes a sliding shaft 233 that is bridged in parallel to the shaft of the platen 236 and slidably holds the carriage 240, a pulley 232 on which an endless driving belt 231 is stretched with the carriage motor 230, a position detection sensor 234 for detecting an original point position of the carriage 240, and so on.

In the carriage 240, a metallic ink cartridge 242 and a color ink cartridge 243 are mounted. The metallic ink cartridge 242 contains a metallic ink (S). The color ink cartridge 243 is an integral type ink cartridge containing a cyan ink (C), a magenta ink (M), a yellow ink (Y) and a black ink (K). In the printing head 241 located under the carriage 240, a total of five types of ink ejection heads 244 to 248 corresponding to these colors are formed. If these ink cartridges 242 and 243 are mounted in the carriage 240 from the upper side, the supply of the inks from the cartridges to the ejection heads 244 to 248 is made possible. The color ink ejection heads 244 to 247 can eject ink droplets while distinguishing large, intermediate and small ink droplets and form large, intermediate and small dots on paper P, as described below. If the large dot is used as a reference dot, the middle dot has an ink amount of about ½ of that of the large dot and the small dot has an ink amount of about ¼ of that of the large dot.

In the control circuit 260 of the printer 200, the CPU, the ROM, the RAM, the PIF (peripheral interface) and so on are connected by the bus, and a main scanning operation and a sub scanning operation of the carriage 240 are controlled by controlling the operations of the carriage motor 230 and the paper feed motor 235. When printing data output from the computer 100 is received via the PIF, driving signals according to the printing data are applied to the ink ejection heads 244 to 248 according to the main scanning or sub scanning movement of the carriage 240 such that these heads can be driven.

The printer 200 having the above-described hardware configuration reciprocally moves the ink ejection heads 244 to 247 of the respective colors with respect to the printing paper P in a main scanning direction by driving the carriage motor 230, and moves the printing paper P in a sub scanning direction by driving the paper feed motor 235. The control circuit 260 drives nozzles at appropriate timings based on the printing data according to the reciprocal movement (main scanning) of the carriage 240 or the paper feed movement (sub scanning) of a printing medium so as to form ink dots of appropriate colors at appropriate positions on the printing paper P. Accordingly, the printer 200 can print a color image on the printing paper P.

Although the printer 200 of the present embodiment is described as a so-called ink jet printer for ejecting ink droplets to the printing medium so as to form ink dots, a printer for forming dots using any method may be used. For example, instead of the ink droplets, the invention is suitably applicable to a printer for attaching toner powders of respective colors to a printing medium using static electricity so as to form dots or a line printer.

Hereinafter, several examples of a printing process executed by the function of the printer driver 24 included in the computer 100 is described.

### C. First Example:

### (C1) Printing Process of First Example:

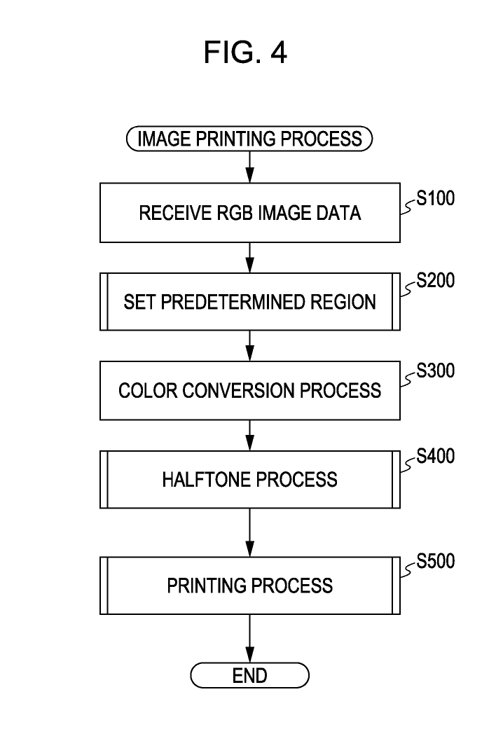

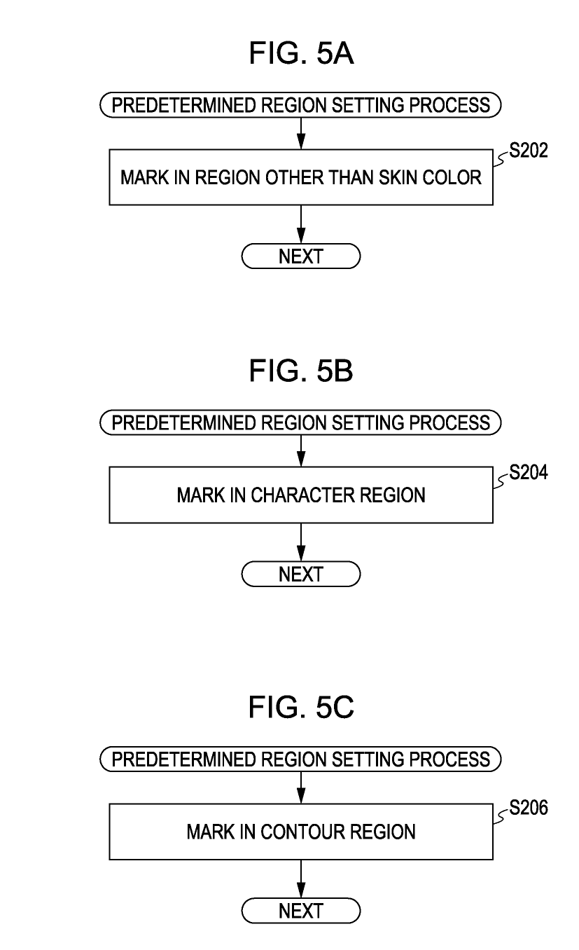

FIG. 4 is a flowchart showing an image printing process according to a first example of the invention. This image printing process is performed by allowing the CPU 102 to execute a prepared program by the printer driver 24 in hardware. When the process of FIG. 4 is started, the printer driver first receives input image data of an RGB format from the application program (step S100). After the image data is received, the printer driver 24 performs a process of setting a predetermined region, in which printing using the metallic ink is performed, using the specific region extraction module 40 (step S200). The predetermined region may be set by various methods, and, among them, for example, as shown in FIG. 5A, a process of extracting a region other than a skin color region and imparting a mark to that region may be used. In the process of extracting the region other than the skin color region, the computer 100 converts a color space of the image data of the RGB format received in the step S100 into a L*a*b* color space, recognizes a region, in which the respective values of L*, a* and b* after conversion are included in a predetermined range, as a skin color region, and imparts the mark to a complementary region. In the present example, a substantially spherical range that is in contact with a rectangular parallelepiped having an L* value of 55 to 85, an a* value of 5 to 25 and a b* value of 5 to 25 determines the skin color region.

The mark imparted in the process of setting the predetermined region is referred to by a post-process. The mark is imparted by preparing a 1-bit flag in every pixel configuring the image data, storing a value 1 with respect to the predetermined region, and storing an initial value 0 with respect to the region other than the predetermined region. The reason why mark is not imparted and the metallic ink is not used with respect to the skin color region is because, if the metallic ink is used in the skin color portion when the image is formed, natural representation is lost, a sense of incongruity is given to a viewing person, and the representation effect due to the use of the metallic ink cannot be sufficiently utilized.

Although the region other than the skin color is set as the predetermined region in the present example, for example, as shown in FIG. 5B, a mark may be imparted to a character region as the predetermined region. The character region is a region in which only characters are formed without a natural image or the like. Alternatively, as shown in FIG. 5C, a mark may be imparted to a contour region. The contour region indicates a range obtained by extracting edges from original image data and adding predetermined peripheral pixels to the edges. By using the metallic ink in such a contour region, unique representation can be obtained. Alternatively, for example, in the application program, a region that is arbitrarily set by a user may be set as a region using the metallic ink by the printer driver 24.

After the region is set, the computer 100 converts the image data of the RGB format received in the step S100 into image data of a CMYK format using the color conversion module 42 (step S300). After the image data of the CMYK format is obtained, the computer 100 performs a halftone process using the halftone module 44 and generates data capable of being transmitted to the printer 200 (step S400). The data capable of being transmitted to the printer 200 is ink droplet data (also referred to as dot data) formed on the paper p by the printer 200, is data in which small, intermediate and large dot are formed or are not formed with respect to the color ink (CMYK), and is data in which a large dot may be formed with respect to the metallic ink.

If the halftone process is completed, the computer 100 controls the printer 200 using the print control module 46, transmits dot data generated by the halftone process to the printer, forms ink droplets on the sheet P by the printer 200, and prints an image (step S500).

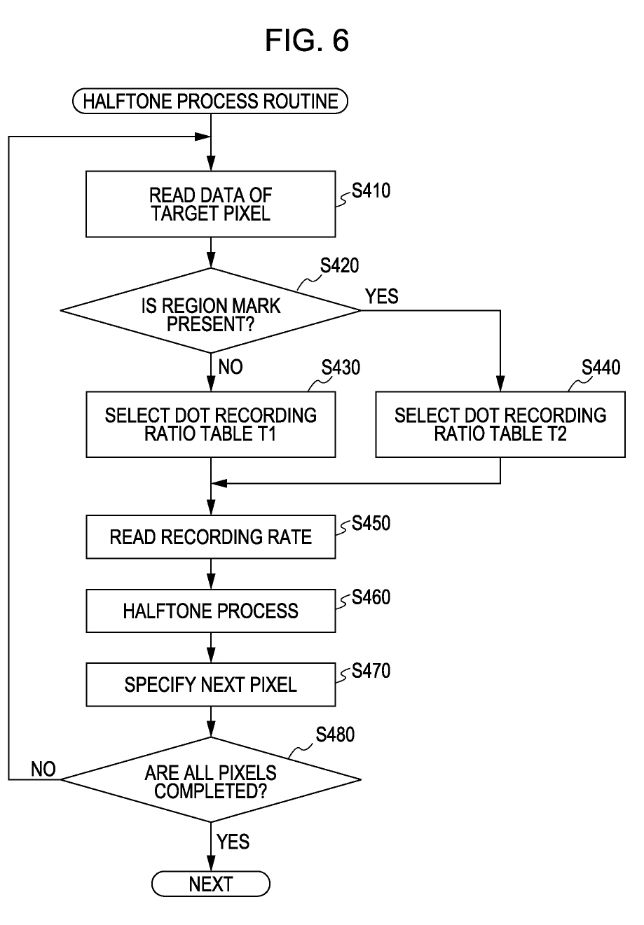

In the above-described image printing process, the characteristic halftone process (step S400) of the present example is described as follows. FIG. 6 is a flowchart showing the halftone process routine. As shown, when this process is started, first, a process of reading data of a target pixel is performed (step S410). An initial position of the target pixel is the upper left corner of the image data.

After the data of the target pixel is read (step S410), next, it is determined whether or not a region mark of this pixel is imparted (step S420). The region mark is imparted to every pixel in the process of setting the predetermined region (step S200), and, as in the first example, for example, the region mark is imparted to the region other than the skin color region. If it is determined that the region mark is imparted, then a process of selecting a dot recording ratio table T1 is performed (step S430) and, if it is determined that the region mark is not imparted, a process of selecting a dot recording ratio table T2 is performed (step S440).

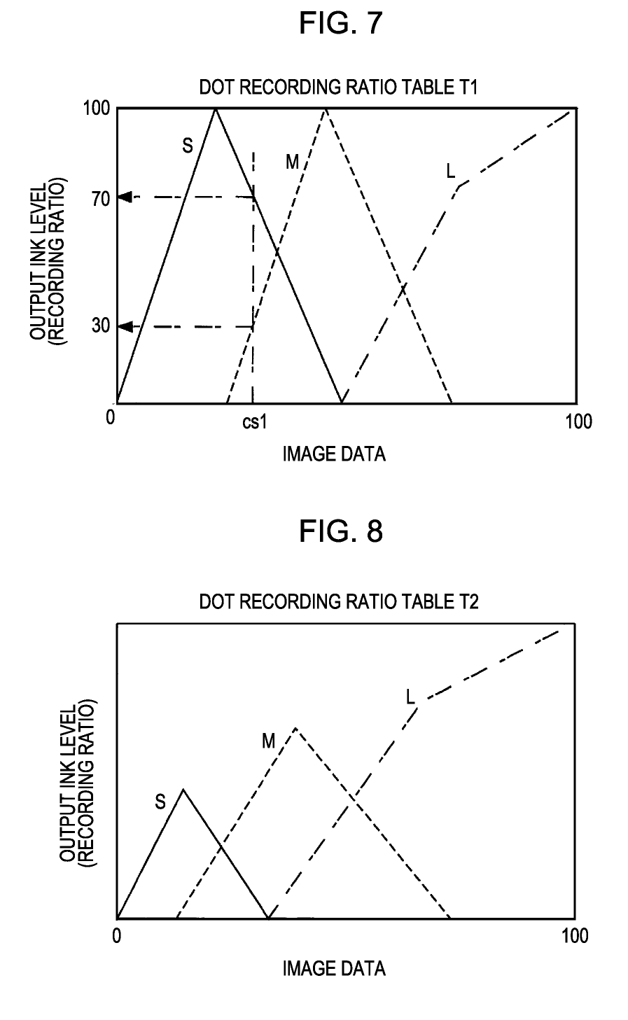

The dot recording ratio tables T1 and T2 are shown in FIGS. 7 and 8, respectively. As shown, both the dot recording ratio tables T1 and T2 are tables for defining the formation ratio of large, intermediate and small dots for the color inks. In the dot recording ratio table t1 applied to the pixels to which the region mark is imparted, as shown in FIG. 7, the recording ratio S of the small dot is gradually increased in an image data range from 0 to 25 until an output ink level (recording ratio) becomes a maximum and, thereafter, is gradually decreased in an image data range up to 50 until the output ink level becomes 0. Similarly, the recording ratio M of the intermediate dot is gradually increased in an image data range from 25 to 50 until the output ink level (recording ratio) becomes a maximum and, thereafter, is gradually decreased in an image data range up to 75 until the output ink level becomes 0. In addition, the recording ratio L of the large dot is gradually increased in an image data range from 50 to 100 until the output ink level becomes a maximum (more accurately, the recording ratio is bent in the vicinity of the image data of 75 and gradually increases at a rate that is lower in a range of 75 or more than in a image data range of 75 or less).

In the dot recording ratio table T2, as shown in FIG. 8, the recording ratio S of the small dot is gradually increased in an image data range from 0 to 15 until the output ink level (recording ratio) becomes 40% of a maximum value and, thereafter, is gradually decreased in an image data range up to 30 until the output ink level becomes 0. Similarly, the recording ratio M of the intermediate dot is gradually increased in an image data range from 15 to 40 until the output ink level (recording ratio) becomes 60% of a maximum value and, thereafter, is gradually decreased in an image data range up to 75 until the output ink level becomes 0. In addition, the recording ratio L of the large dot is gradually increased in an image data range from 30 to 100 until the output ink level becomes a maximum (more accurately, the recording ratio is bent in the vicinity of the image data of 65 and gradually increases at a rate that is lower in a range of 65 or more than in a image data range of 65 or less).

In a comparison of both tables, when the halftone process of the color ink is performed using the dot recording ratio table T1 or the dot recording ratio table T2, if the same image data is used, it can be seen that the formation ratio of the small dot or the intermediate dot is higher in the table T1 and the formation ratio of the large dot is higher in the table T2.

After the selection of the dot recording ratio table is performed, a process of reading the output ink level (recording ratio) with respect to the target pixel is performed (step S450). Since the target pixel has a predetermined value with respect to the inks of CMYK, the tables T1 or T2 of FIG. 7 or FIG. 8 is referred to based on that value (image data) and the data of a corresponding output ink level (recording ratio) is acquired. Subsequently, the halftone process using the systematic dither method is performed using the read output ink level (recording ratio) (step S460). The systematic dither method is a known technique and thus the detailed description thereof is omitted. That is, the value of each of elements of a dither matrix that is prepared in advance and the value of the output ink level (recording ratio) are compared, and it is determined that a dot is formed at that pixel if the output ink level is large and a dot is not formed if the output ink level is small.

With the color ink, by referring to the table T1 or T2 based on image data, the output ink level may be read with respect to two or more types of dots. For example, when the table T1 is referred to, with respect to the image data cs1, two or more types of output ink levels may be read like:

Output ink level of the small dot S=30

Output ink level of the intermediate dot M=70.

In this case, first, the value (here, M=70) of the dots of the large size and the element value d1 corresponding to the dither matrix are compared to determine ON/OFF of the dot. If the dot having that size is formed, the determination of a dot (here, the small dot) smaller than that dot (here, the intermediate dot) is not performed (accordingly, a smaller dot is not formed), and, if the dot having that size is not formed, the determination of the dot smaller than that dot is performed.

After the halftone process of one pixel is completed, a next pixel is specified (step S470) and it is determined whether the process of all the pixels is completed (step S480). If the process of all the pixels is not completed, the process returns to the step S410 and the above-described process is repeated. In contrast, if the process of all the pixels is completed, the halftone process is completed via “NEXT”.

Next, the printing process (S500) of the image printing process (FIG. 4) is described. After ON/OFF of each of the large, intermediate, small dots for the color ink is completed by the above-described halftone process, the printing process is next performed. If the printing process is started after the overall halftone process of the image to be printed is completed, the data of ON/OFF of the dots for all the pixels is stored in the RAM 106, and is read and used in the printing process. Actually, if the halftone process of a predetermined range (band) is completed and the halftone process of a next range is started, the printing process may be started in parallel to this and the printing may be performed with respect to the range in which the halftone process is completed.

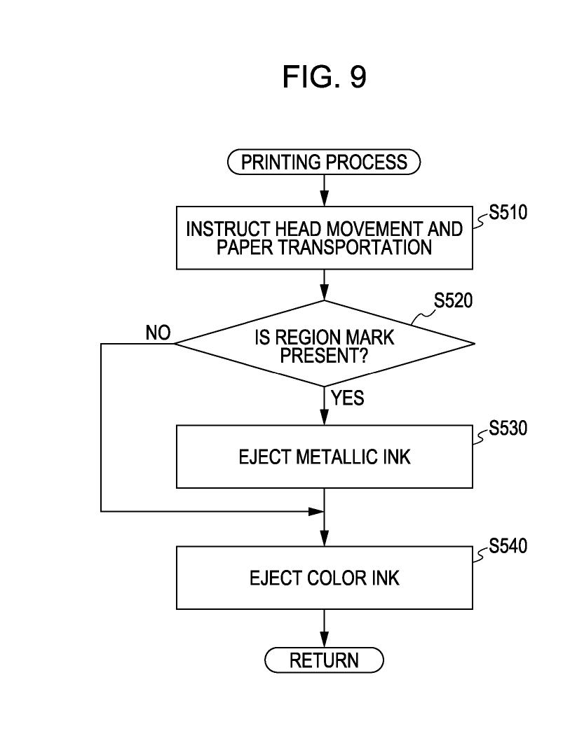

Although the printing process (step S500) is actually a process performed by the printer 200, the printing device in which the computer 100 and the printer 200 are integrally formed is described. As the printing process (step S500) is started, as shown in FIG. 9, the printer driver 24 sends a command for instructing the movement of the printing head 241 or the transportation of the paper P to the printer 200 and the printer 200 performs the movement of the printing head 241 or the transportation of the paper P (step S510). Subsequently, the printer driver 24 determines whether or not the region mark is imparted to the pixel to be printed (step S520). If the region mark is imparted, since the pixel is the region using the metallic ink, the ejection of the metallic ink is continuously performed (step S530). The metallic ink in the metallic ink cartridge 242 is ejected from the ink ejection head 248 as ink droplets.

After the ink droplets of the metallic ink is ejected or without performing the ejection of the metallic ink when it is determined that the region mark is not imparted, the ejection of the color ink is continuously performed (S540). It is determined how large the dot is formed at which pixel by the halftone process, and, in the printing process shown in FIG. 9, the ink droplets of the metallic ink or the color ink are sequentially ejected according to the result of the halftone process, while performing the movement of the printing head 241 and the transportation of the paper. By performing the printing process of FIG. 9 with respect to overall image data, the metallic ink is ejected at a place where the region mark is imparted, the metallic ink is not ejected and only the color ink is ejected in accordance with the image data at a place where the region mark is not imparted.

In the present example, bidirectional printing is not performed and the printing is performed only when the carriage 240 is moved in the main scanning direction (from the left side to the right side of the drawing) of FIG. 3. Accordingly, from the viewpoint of the paper P, the ejection of the metallic ink is first performed and the ink droplets of the color ink are then ejected.

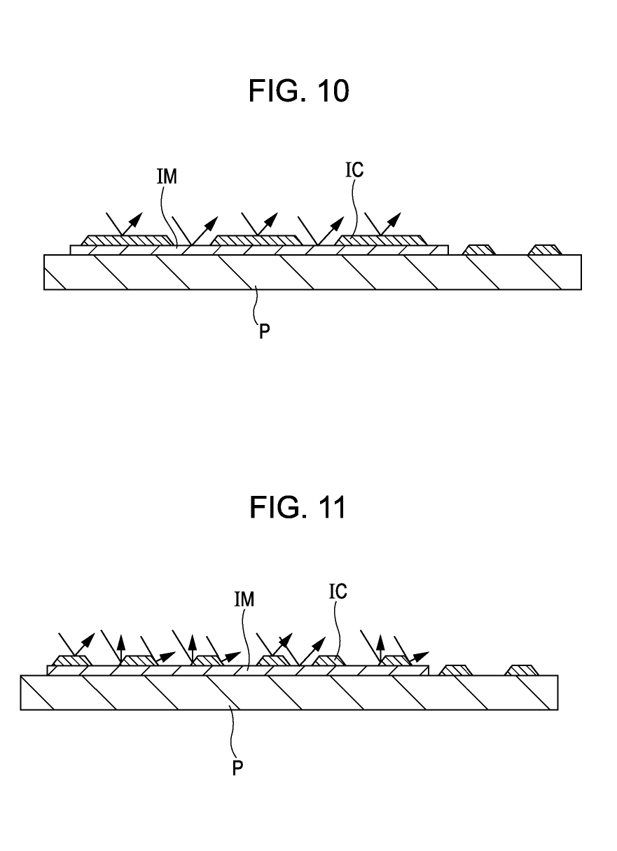

A state in which the ink is ejected on the paper P in the respective regions is shown in FIG. 10. As shown, with the region to which the region mark is imparted, the metallic ink IM is first ejected on the sheet P and the color ink IC is then ejected. Accordingly, the color ink is satisfactorily represented on the paper P without covering the color ink IC with the metallic ink IM. In addition, in the present example, in the region other than the skin color region, the metallic ink IM is used and the table suitable for the region using the metallic ink is selected as the dot recording ratio table. As a result, with respect to the same image data, the formation ratio of the large dot is increased. Accordingly, as shown in FIG. 10, the light incident to this paper P is reflected from the metallic ink layer or the color ink layer that is widely formed thereof and a glossy quality is not lost. By scattering at the edges of the color ink or the like, the lost fraction of the glossy quality is small.

In contrast, if the dot recording ratio table T1 is used even in the region other than the skin color region, with respect to the same image data, a larger amount of small dots is formed and, as shown in FIG. 11, the scattering of the light at the edges of the color ink region is susceptible to be generated. As a result, the glossy quality is lost in the region using the metallic ink and a dull color is susceptible in result. In the present example, by a process of changing the dot recording ratio table according to the regions, a dull quality in the region using such a metallic ink is avoided and a unique representation using the metallic ink is sufficiently realized.

### (C2) First Modified Example:

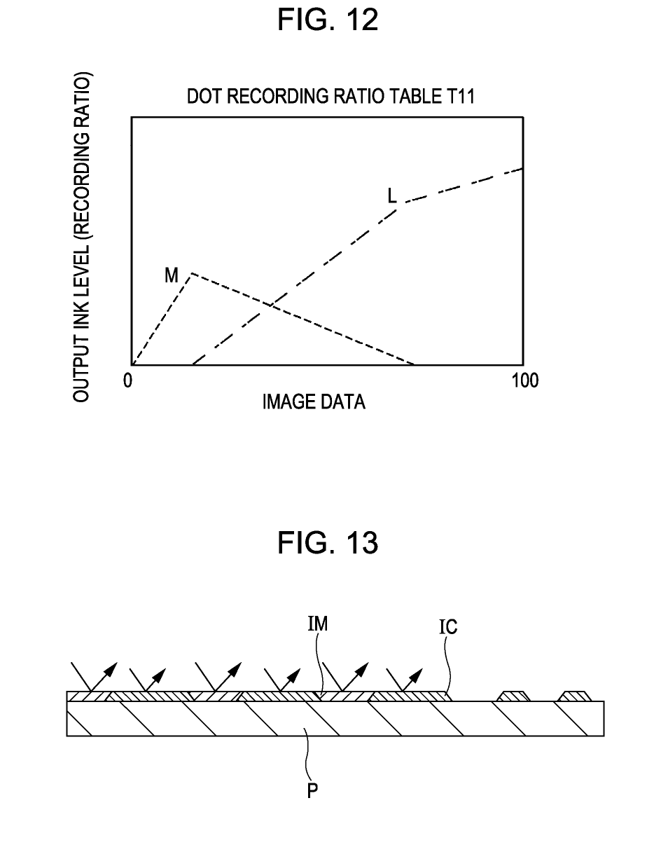

Although a combination of FIGS. 7 and 8 is used as the dot recording ratio table in the above-described first example, a table T11 shown in FIG. 12 may be used as the dot recording ratio table used in the region using the metallic ink. In this table T11, with respect to the image data, the recording ratio S of the small dot is 0 and the recording ratio M of the intermediate dot is set such that the intermediate dot is formed from a range in which the image data is small. The recording ratio L of the large dot is set such that the large dot is formed in a range in which the image data is smaller than that of the table T2 shown in FIG. 8 (a range in which a gradation value is low). As a result, in the region using the metallic ink, the small dot is not formed and only the intermediate dot and the large dot are formed. Accordingly, it is possible to further suppress the generation of the dullness of the color ink due to the scattering of the light, compared with the first example.

### (C3) Second Modified Example:

Although the color ink is ejected on the metallic ink in the first example, as shown in FIG. 13, even in the region using the metallic ink, the color ink may be ejected in the region in which the printing using the metallic ink is not performed. Even in this case, in the region using the metallic ink, the color ink is formed by a relatively large dot such that the scattering of the light is suppressed and the dullness of the color in the region using the metallic ink is suppressed.

### (C4) Third Modified Example:

In the first example, in the first printing head 241, the metallic ink cartridge 242 and the ink ejection head 248 thereof are arranged in parallel to the color ink cartridge 243 and the ink ejection heads 244 to 247 thereof in the main scanning direction and the printing is performed in one direction such that the metallic inks is first ejected on the paper P in the same main scanning. In contrast, one raster may be formed by a plurality of number of times of scanning, a path to eject the metallic ink may be first provided, and the color ink may be ejected with respect to the same raster. By combining with an interlace using a so-called overlap printing method, efficiently, printing using the metallic ink may be first performed and the color ink may be ejected thereon after the printing using the metallic ink. In such a case, bidirectional printing may be employed, instead of unidirectional printing. In this case, the position of the nozzle array for the metallic ink may be freely set. For example, one of the ink ejection heads 244 to 247 for the color ink may be used as a printing head for the metallic ink and the ink ejection head 248 may be used as the printing head for ejecting one color ink, such as the black ink or the like.

### D. Second Example:

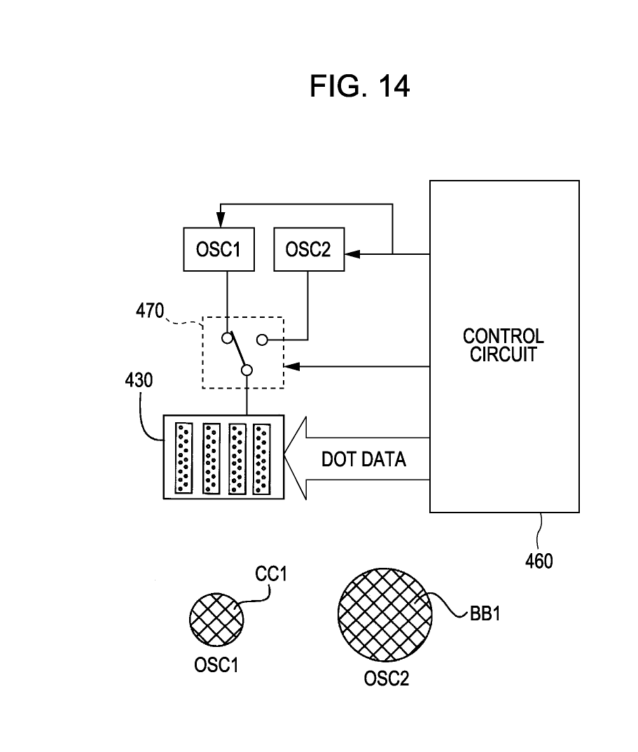

Next, a second example of the invention is described. The second example is similar to the first example in the basic hardware configuration, except that the ink droplets are ejected from the printing head by the instruction from the control circuit of the printer 200. FIG. 14 is a view showing a mechanism for ejecting the ink droplets in the printer of the second example. In an ink jet printer, a plurality of actuators corresponding to nozzles is provided in the printing head. As the actuator, an actuator for distorting a piezo element or the like according to an electrical signal and ejecting (discharging) ink droplets from nozzle front ends using the distortion, a bubble jet type actuator for conducting and heating a heater provided in an ink passage, subjectively generating air bubbles (bubbles) in the ink of the ink passage, and ejecting (discharging) ink droplets by the growth of the air bubbles or the like is known. In either case, in order to efficiently drive the plurality of actuators, a configuration for outputting dot data corresponding to the nozzles of the respective colors (signal corresponding to ON/OFF of the ink droplets) and driving signals for driving the plurality of actuators from the control circuit, driving the plurality of actuators by the driving signals, and simultaneously ejecting from the plurality of nozzles is employed. The driving signals are generated by a general dedicated oscillator OSC.

In the second example, as shown in FIG. 14, the dot data corresponding to the dot to be formed is output from the control circuit 460 to the piezo element provided in the printing head 430, and, two oscillators OSC1 and OSC2 are prepared for the output of the driving signals. A switch 470 for selecting which of the driving signals of the oscillator OSC1 and the oscillator OSC2 is provided, and a connection may be switched by the instruction from the control circuit 460. Although any one of the oscillator OSC1 or the oscillator OSC2 is used, when the driving signal from the oscillator is given, the piezo element of which the dot data has a high level (value 1) is driven by the driving signal from the oscillator and thus ink droplets are ejected.

In the second example, the oscillators OSC1 and OSC2 are different in the driving waveform, and, when the oscillator OSC2 is used, the large dot can be formed, compared with the oscillator OSC1 is used. Accordingly, with respect to the region using the metallic ink, a switching signal is output from the control circuit 460, the switch 470 is switched, and the oscillator OSC2 is used when the color ink dot is formed. Even in this case, as shown in FIG. 10, the ink droplets of the color ink formed on the metallic ink is increased, the scattering of the light is suppressed, and the dullness of the color ink is reduced.

In the configuration shown in FIG. 14, since the driving signals to the actuators in the printing head 430 are simultaneously switched, all the dots that are simultaneously formed become the large dots. Accordingly, since the region using the metallic ink and the region without using the metallic ink are mixed within the range of the width direction of the nozzle array according to the transportation direction of the paper P, each raster is formed by a plurality of paths, printing using the metallic ink is first performed, printing using the color ink is next performed in the region except the region using the metallic ink using the oscillator OSC1, and printing using the color ink is lastly performed in the region using the metallic ink using the oscillator OSC2. If the region using the metallic ink and the region without using the metallic ink are divided in the main scanning direction, the switch 470 is switched during the transportation of the printing head 430 in the main scanning direction.

### E. Other Modified Example:

The invention may be embodied even in the configuration other than the above-described several examples. For example, the invention is applicable to a color page printer for performing printing using a photosensitive drum and a toner. In this case, a latent image is formed on the photosensitive drum by a plurality of numbers of times and the toner attached to the latent image is transferred to paper by a plurality of numbers of times. Accordingly, a metallic toner is first transferred to the paper, is melted and fixed using a heating roller or the like, and a color toner is then transferred. At this time, in the region using the metallic toner, the color toner is transferred using a large halftone dot, compared with the region without using the metallic toner. Originally, if the large halftone dot is used, the halftone dots are sparsely arranged. As a result, in the region using the metallic toner, the color toner is transmitted by the large halftone dot, the scattering at the edges of the color toner is suppressed, and the dullness of the color using the color toner is suppressed.

A combination of the printing using the photosensitive drum and the toner and the ink jet printing is possible. In this case, the printing using the metallic toner is first performed and, thereafter, the printing using the color ink is performed. If both printing processes are sequentially performed, it is difficult to match the printing position with accuracy, but the region using the metallic toner and the region without using the metallic toner do not need to be aligned with accuracy, for example, like a portion of the label or the like. In such a case, the printing using the metallic toner may be first performed and the color ink jet printing may be then performed. Even in such a case, in the printing using the color ink, in the region using the metallic toner, it is possible to suppress the dullness of the color of the color ink due to the scattering of the light, by forming a large amount of color ink. Since the printing using the color ink is performed after the metallic printing using the toner, the ink droplets of the color ink are mixed with the ink droplets of the metallic ink and the color of the color ink can be made vivid.

Although a so-called serial scheme for moving the printing head in the main scanning direction in both the first and second examples, the present invention is embodied in a so-called line printer in which nozzles having resolution corresponding to printing resolution are arranged over the width direction of paper.

Although general opaque paper is used as the paper P in the above-described examples, printing may be performed with respect to a transparent sheet, such as an OHP sheet, a transparent sheet attached to a bottle, a glass surface bulletin transparent poster or the like. In such a case, if the “transparent sheet”, the “OHP sheet” or the like is selected by the printer driver, the formation order of the metallic ink and the color ink is reversed, the printing using the color ink may be first performed and examination using the metallic ink may be performed. Originally, in the region in which the printing using the metallic ink is performed, the color ink is printed using the large dot. In this case, a printing surface is viewed through the transparent sheet, similar to the above-described examples, the scattering due to the color ink can be reduced, and the dullness of the color can be suppressed.

In the above-described embodiments, in the printing system 10 including the computer 100 and the printer 200, the printing using the metallic ink is performed. In contrast, the printer 200 may receive the image data from the digital camera or various types of memory cards and perform the printing using the metallic ink. That is, the CPU of the control circuit 260 of the printer 200 may perform the same process as the printing process in the above-described examples and perform the printing using the metallic ink.

What is claimed is:

1. A printing device that prints an image using a metallic ink and a color ink, the device comprising:
a recording unit that records the metallic ink and the color ink on a printing medium;
an input unit that inputs image data;
a metallic ink region specifying unit that specifies a region using the metallic ink, in the formation of the image according to the input image data; and
a print control unit that prints the image while the color ink in the region using the metallic ink is formed relatively larger than that of a region without using the metallic ink.

2. The printing device according to claim 1, wherein the print control unit makes the dots of the color ink recorded from the recording unit large in the region using the metallic ink.

3. The printing device according to claim 1, wherein:
the recording unit can form at least two or more types of dots having different sizes, and
the print control unit increases a formation ratio of a large dot of the two or more types of dots in the dots of the color ink recorded from the recording unit, with respect to the region using the metallic ink.

4. The printing device according to claim 1, wherein:
the recording unit can form large, intermediate and small dots, and
the print control unit increases a formation ratio of the large dot of the large, intermediate and small dots in the dots of the color ink recorded from the recording unit, with respect to the region using the metallic ink.

5. The printing device according to claim 1, wherein the metallic ink region specifying unit extracts at least one of a setting region set by a user, a non-skin color region other than a region in which a skin color occupies a predetermined area, a character region in which characters are present, or a contour region in which a contour of image data is present, and specifies the extracted region as the region using the metallic ink.

6. The printing device according to claim 1, wherein the print control unit forms the dots of the color ink so as to be superimposed on the dots formed by the metallic ink, with respect to the region using the metallic ink of an opaque print medium.

7. The printing device according to claim 1, wherein the print control unit forms the dots of the metallic ink so as to be superimposed on the dots formed by the color ink, with respect to the region using the metallic ink of a transparent print medium.

8. The printing device according to claim 1, wherein the print control unit forms the dots of the color ink and the dots of the metallic ink without being superimposed, with respect to the region using the metallic ink.

9. The printing device according to claim 1, wherein at least one of a unit which performs recording by ejecting ink droplets from nozzles by distortion of a piezo element, a unit which performs recording by ejecting ink droplets from the nozzles by bubbles generated by heating of a heater, a unit which performs recording by attaching a toner to a latent image formed on an optical drum and transferring the toner to paper is employed as the recording unit.

10. A print control device that allows a printing device including a recording unit, which records a metallic ink and a color ink on a printing medium, to print an image, the device comprising:
an input unit that inputs image data;
a metallic ink region specifying unit that specifies a region using the metallic ink, in the input image data; and
an output unit that outputs printing data in which the dots of the color ink are relatively large dots in a region using the metallic ink, compared with a printing region without using the metallic ink.

11. A printing method that prints an image using a metallic ink and a color ink by a printing device, the method comprising:
preparing a recording unit that records the metallic ink and the color ink on a printing medium;
specifying a region using the metallic ink, in the formation of the image according to input image data; and
printing the image while the color ink is relatively large dots in the region using the metallic ink, compared with a region without using the metallic ink.

12. A computer program printing an image using a printing device including a recording unit, which records using a metallic ink and a color ink on a printing medium, the program comprising: on a computer,
a function of specifying a region using the metallic ink, in the formation of the image according to input image data; and
a function of printing the image while the color ink is relatively large dots in the region using the metallic ink, compared with a region without using the metallic ink.

13. A computer-readable recording medium comprising the computer program according to claim 12 recorded thereon.
